(19) United States
(12) Patent Application Publication
(10) Pub. No.: US 2024/0163163 A1
(43) Pub. Date: May 16, 2024

(54) LOCATION AND OWNERSHIP-CHANGE BASED AUTOMATIC PROFILE CONFIGURATION FOR COMMUNICATION DEVICE

(71) Applicant: Honda Motor Co., Ltd., Tokyo (JP)

(72) Inventors: BONNIE CHEN HONG, Torrance, CA (US); DAVID M. KIRSCH, Torrance, CA (US)

(21) Appl. No.: 17/987,685

(22) Filed: Nov. 15, 2022

(51) Int. Cl. H04L 41/0813; H04L 67/30; H04L 67/52

(52) U.S. Cl. CPC H04L 41/0813; H04L 67/30; H04L 67/52

(57) ABSTRACT

A communication device and method for automatic profile configuration is provided. The communication device receives, from a server, a first profile including a first set of features or settings of the communication device. The first profile is configured to control the electronic device. The communication device uses a location sensor associated with the communication device to track a location of the communication device. The communication device determines whether the communication device is beyond a predefined distance from a predefined location. The communication device receives, from the server, ownership update information indicative of an event of an ownership change associated with the communication device. The communication device removes the generated first profile from the communication device, based on the determination that the tracked location is beyond the predefined distance and the ownership update information.

### BACKGROUND

Advancements in electronics and computing technology have led to development of electronic and communication devices including various features to perform predefined functions. Examples of the electronic and communication devices may include infotainment systems of vehicles, mobile phones, televisions, laptops, and the like. To use an electronic device or a communication device, one or more features of the device may be configured in a certain mode. When such devices may be showcased by a seller to a customer, the one or more features may be configured in a predefined mode to provide a certain experience to the customer and persuade the customer to purchase the device. However, the device may be required to be personalized for the customer, post the purchase of the device by the customer.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An exemplary aspect of the disclosure provides a communication device. The communication device may include circuitry. The circuitry may receive, from a server, a first profile, including a first set of features or settings. Herein, the received first profile may be configured to control the communication device. The circuitry may track, using a location sensor associated with the communication device, a location of the communication device. The circuitry may determine whether the communication device is beyond a predefined distance of a predefined location, based on the tracked location of the communication device. The circuitry may receive, from the server, ownership update information indicative of an event of an ownership change associated with the communication device. The circuitry may remove the received first profile from the communication device, based on the determination that the tracked location is beyond the predefined distance and the received ownership update information.

Another exemplary aspect of the disclosure provides a method. The method may include reception, from a server, a first profile, including a first set of features or settings. Herein, the received first profile may be configured to control the communication device. The method may further include tracking, using a location sensor associated with the communication device, a location of the communication device. The method may further include determination of whether the communication device is beyond a predefined distance of a predefined location, based on the tracked location of the communication device. The method may further include reception, from the server, ownership update information indicative of an event of an ownership change associated with the communication device. The method may include removal of the received first profile from the communication device, based on the determination that the tracked location is beyond the predefined distance and the received ownership update information.

Another exemplary aspect of the disclosure provides a non-transitory computer-readable medium having stored thereon, computer-executable instructions. The computer-executable instructions that when executed by a processor may cause the processor to execute operations. The operations may include generating a first profile, including a first set of features or settings, for each of a set of communication devices. Herein, the generated first profile may be configured to control the corresponding communication device. The operations may track, using a location sensor associated with the corresponding communication device, a location of the corresponding communication device. The operations may determine whether the corresponding communication device is beyond a predefined distance of a predefined location, based on the tracked location of the corresponding communication device. The operations may receive ownership update information indicative of an event of an ownership change associated with the corresponding communication device. The operations may remove the generated first profile from the corresponding communication device, based on the determination that the tracked location is beyond the predefined distance and the received ownership update information.

### BRIEF DESCRIPTION OF THE DRAWINGS

FIG. 1 is a diagram that illustrates an exemplary network environment for automatic profile configuration based on location and ownership change, in accordance with an embodiment of the disclosure.

FIG. 2 illustrates a block diagram of an exemplary communication device of FIG. 1, in accordance with an embodiment of the disclosure.

FIG. 3 illustrates a block diagram of an exemplary server of FIG. 1, in accordance with an embodiment of the disclosure.

FIG. 4 is a diagram that illustrates an exemplary processing flow for automatic profile configuration by a communication device based on location and ownership change of the communication device, in accordance with an embodiment of the disclosure.

FIG. 5 is a diagram that illustrates an exemplary processing flow for automatic profile configuration by a server based on location and ownership change of a communication device, in accordance with an embodiment of the disclosure.

FIG. 6 illustrates a flowchart of an exemplary method for automatic profile configuration by a communication device based on location and ownership change of the communication device, in accordance with an embodiment of the disclosure.

FIG. 7 illustrates a flowchart of an exemplary method for automatic profile configuration by a server based on location and ownership change of a communication device, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a communication device, a server, and a method of automatic profile configuration on the communication device, based on location and ownership change. Exemplary aspects of the disclosure provide a communication device that includes circuitry that may receive a first profile including a first set of features or settings of the communication device. The first profile may be configured to control the communication device. Examples of the communication device may include a vehicle, a mobility device, a mobile device, a consumer electronic device with the location sensor, or a computing device with the location sensor. In an example, the first profile may include information related to social applications, streaming services, preloaded destinations, test drives, temperature settings, Heating Ventilation and Air-Conditioning (HVAC) settings, or tutorials associated with an infotainment system of the communication device. The first profile may be generated by a server associated with the communication device. The server may transmit the first profile to the communication device. The circuitry may further track, using a location sensor (associated with the communication device), a location of the communication device. The circuitry may determine whether the communication device is beyond a predefined distance from a predefined location, based on the tracked location of the communication device. The circuitry may further receive ownership update information indicative of an event of an ownership change associated with the communication device. In an example, the ownership update information may include one or more of identification information of the communication device, a name of a user associated with the communication device, an address of the user, and payment details associated with the ownership update information of the communication device. The circuitry may further remove the first profile from the communication device, based on the determination that the communication device is beyond the predefined location and the received ownership update information.

Exemplary aspects of the disclosure further provide a server that may include circuitry. The server may generate a first profile, including a first set of features or settings, for each of a set of communication devices. The first profile may be configured to control the corresponding communication device of the set of communication devices. The server may be configured to track, using a location sensor associated with each of the set of communication devices, a location of the corresponding communication device of the set of communication devices. Further, the server may be configured to determine whether the corresponding communication device is beyond a predefined distance from a predefined location, based on the tracked location of the corresponding communication device. The server may be further configured to receive ownership update information indicative of an event of an ownership change associated with the corresponding communication device. For example, the ownership update information may be received from a database. The server may be further configured to remove the first profile from the corresponding communication device, based on the determination that the corresponding communication device is beyond the predefined distance from the predefined location and the received ownership update information.

Typically, communication devices may include various features associated with different functions. To use a communication device, one or more features of the communication device may be configured in a certain mode. A seller or a manufacture of the communication device may not have time to demonstrate each feature of the communication device to a customer (for example at the time of selling). When the communication device is showcased to the customer, a set of selected features (e.g., a few features that may differentiate the communication device from other such devices of competitor companies) may be demonstrated. Such set of selected features may be configured in a predefined mode to provide a certain experience to the customer and persuade the customer to purchase the communication device. Hence, the seller or the manufacturer may create a default profile (e.g., a first profile) including the set of selected features configured in the predefined mode for demonstration of the communication device to the customer. However, when the customer purchases the communication device, the default profile may no longer be needed. The customer may wish to create a personalized profile.

The communication device (and/or the server) may remove the first profile (e.g., the default profile) from the communication device, based on the determination that the tracked location of the communication device is beyond the predefined distance from the predefined location and the received ownership update information. Thus, once the customer purchases the communication device (as determined based on the received ownership updated information) and the communication device is moved beyond the predefined distance (e.g., a geofence around a showroom of the communication device), the first profile (i.e., the default profile created by the seller or the manufacturer) may be automatically removed. Thereafter, the customer may personalize the communication device as per the customer's preference. All default modes of the various features may be reset, and the communication device may enable the customer to create a personalized profile (e.g., a second profile) on the communication device. Thus, the customer may be offered a personalized experience after the purchase of the communication device, subject to a movement of the communication device beyond a certain distance from the location of the showroom (e.g., which may correspond to the location of the server).

Also, in case the communication device moves beyond the predefined distance from the location of the server, but the communication device is not purchased by the customer, the communication device may still retain the default profile (i.e., the first profile). For example, if the communication device corresponds to a vehicle, which may be driven on a test drive but not purchased by the customer, the first profile may not be removed from the communication device. Thus, the seller would not have to re-configure the communication device (i.e., the vehicle) after the test drive, if the customer does not purchase the communication device.

Reference will now be made in detail to specific aspects or features, examples of which are illustrated in the accompanying drawings. Wherever possible, corresponding, or similar reference numbers will be used throughout the drawings to refer to the same or corresponding parts.

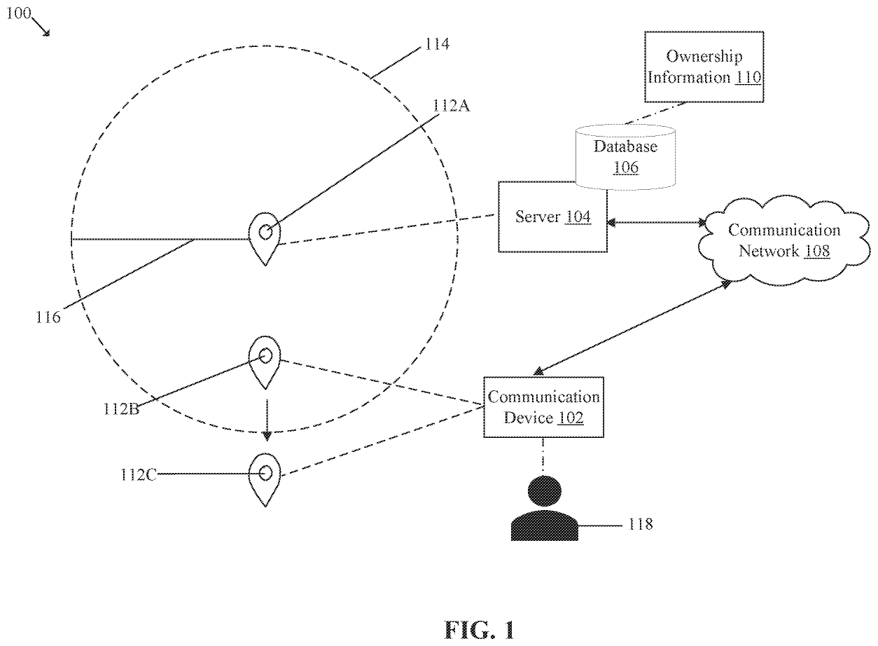

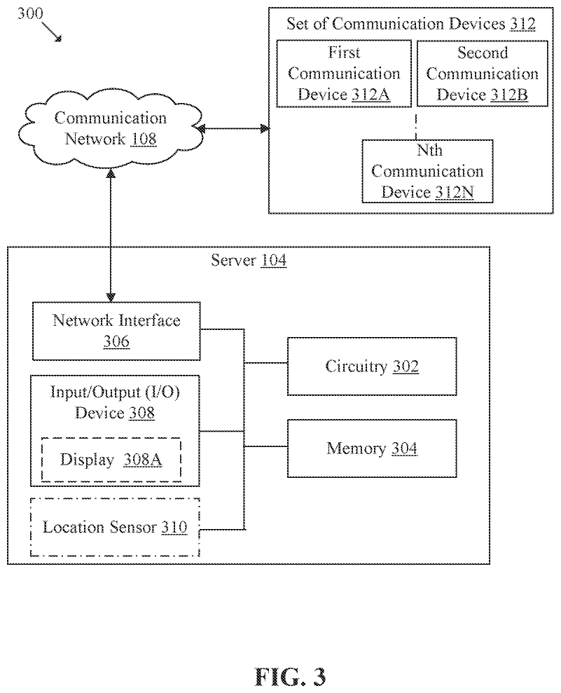

FIG. 1 is a diagram that illustrates an exemplary network environment for automatic profile configuration based on location and ownership change, in accordance with an embodiment of the disclosure. With reference to FIG. 1, there is shown an exemplary network environment 100. In the exemplary network environment 100, there is shown a communication device 102, a server 104, and a database 106. The database 106 may store ownership information 110. The communication device 102 and the server 104 may be communicatively coupled to each other via a communication network 108. There is further shown a user 118 associated with the communication device 102. Further, though not shown in FIG. 1, the network environment 100 may include a set of communication devices (for example, a set of communication devices 312 of FIG. 3), instead of a single communication device, without departure from the scope of the disclosure.

The server 104 may be located at a predefined location 112A. The communication device 102 may be located at a first location 112B at a first time instant T1. The communication device 102 may move from the first location 1126 to a second location 112C. The communication device 102 may be located at the second location 112C at a second time instant T2, after the first time instant T1. In FIG. 1, there is further shown, a predefined region 114 associated with the predefined location 112A. The predefined location 112A and the first location 1126 may lie within the predefined region 114, while the second location 112C may lie outside the predefined location 112A. There is also shown, a predefined distance 116 between the predefined location 112A and a boundary of the predefined region 114. In an example, the predefined region 114 may correspond to a circle with the predefined location 112A as the center of the circle. The predefined location 112A, the first location 112B, the second location 112C, the predefined region 114, and the predefined distance 116, as shown in FIG. 1, are for exemplary purposes and should not be construed to limit the scope of the disclosure.

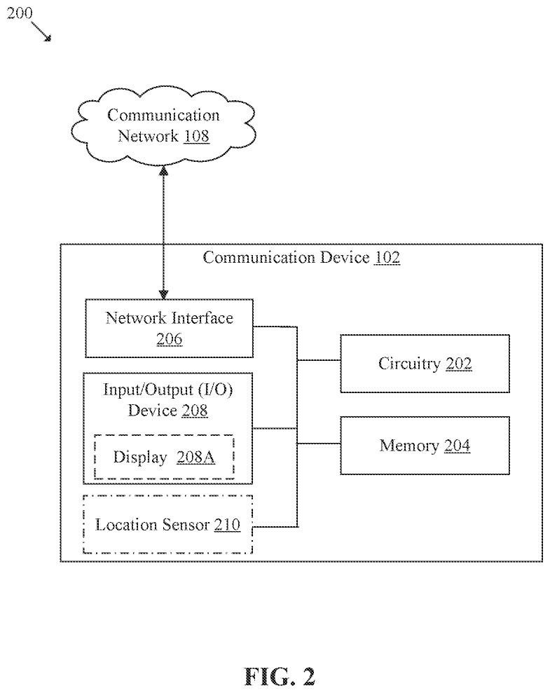

The communication device 102 may include suitable logic, circuitry, and interfaces that may be configured to receive or generate a first profile including a first set of features or settings of the communication device 102. In an embodiment, the communication device 102 may receive the first profile from the server 104. The communication device 102 may include or may be associated with a location sensor (for example, a location sensor 210 of FIG. 2). The communication device 102 may use the location sensor to track a location of the communication device 102. Based on the tracked location and a change in the ownership information 110, the communication device 102 may be configured to remove the first profile. In an embodiment, the communication device 102 may correspond to, but is not limited to, a vehicle, a mobility device, a mobile device, a consumer electronic device with the location sensor, or a computing device with the location sensor. In an embodiment, the communication device 102 may be a part of or may be integrated into the vehicle. For example, the communication device 102 may correspond to an infotainment system of a vehicle. In an embodiment, the communication device 102 may be a microprocessor. Other examples of the communication device 102 may include, but are not limited to, a vehicle control system, an in-vehicle infotainment (IVI) system, an in-car entertainment (ICE) system, an automotive dashboard, an embedded device, a smartphone, a human-machine interface (HMI), a computer workstation, a handheld computer, a cellular/mobile phone, a portable consumer electronic (CE) device, a server, and other computing devices.

The server 104 may include suitable logic, circuitry, and interfaces, and/or code that may be configured to generate or receive the first profile including the first set of features or settings of the communication device 102 (or the set of communication devices 312, shown in FIG. 3). The server 104 may transmit the first profile to the communication device 102. The server 104 may be further configured to determine whether the communication device 102 (or the set of communication devices 312 of FIG. 3) is beyond a predefined distance (such as, the predefined distance 116) from a predefined location (such as, the predefined location 112A), based on the tracked location of the communication device 102 (or the set of communication devices 312 of FIG. 3). The server 104 may be further configured to remove the first profile from the communication device 102 (or the set of communication devices 312 of FIG. 3), based on the tracked location and a change in the ownership information 110. For example, the first profile may be removed if the tracked location is beyond the predefined distance 116. In an embodiment, the server 104 may be associated with a first user (e.g., a seller, a manufacturer, or a manufacturer's dealer), and the communication device 102 may be associated with a second user (e.g., the user 118) different from the first user. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the communication device 102 as two separate entities. In certain embodiments, the functionalities of the server 104 can be incorporated in its entirety or at least partially in the communication device 102, without a departure from the scope of the disclosure.

The database 106 may include suitable logic, interfaces, and/or code that may be configured to store the ownership information 110. In certain embodiments, the database 106 may further store the first profile. In such case, the database 106 may transmit the first profile to the communication device 102 and/or the server 104, based on a query for the first profile received by the database 106. The database 106 may be derived from data off a relational or non-relational database. The database 106 may be stored or cached on a device, such as a server (such as, the server 104) or the communication device 102. The device that stores the database 106 may be configured to receive a query for the ownership information 110 from the communication device 102 and/or the server 104. In response, the device of the database 106 may be configured to retrieve and provide the queried ownership information 110 to the communication device 102 and/or the server 104, based on the received query.

In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the communication device 102 and the server 104 may communicate with each other. The communication network 108 may be one of a wired connection or a wireless connection. Examples of the communication network 108 may include, but are not limited to, the Internet, a cloud network, Cellular or Wireless Mobile Network (such as Long-Term Evolution and 5G New Radio), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

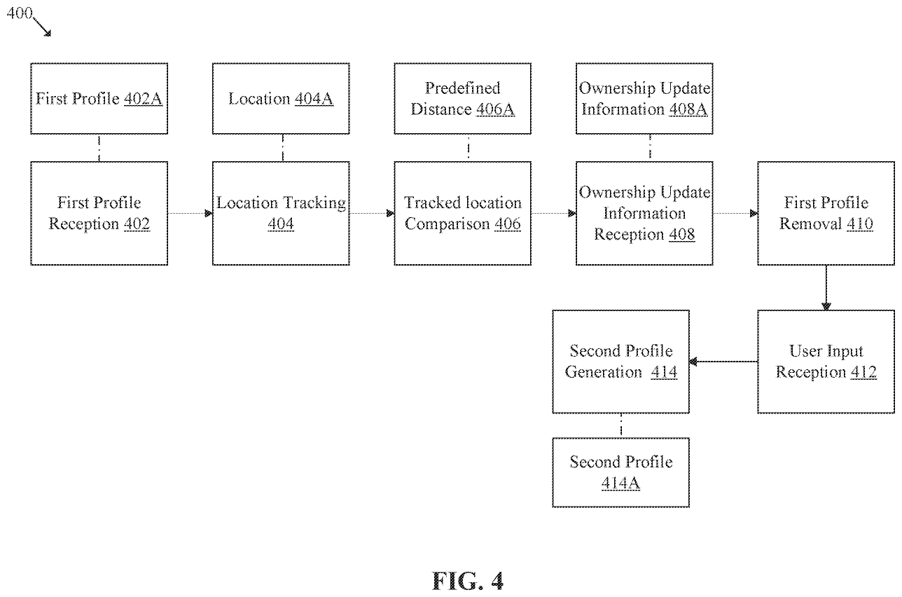

In operation, the communication device 102 may generate or receive the first profile including the first set of features or settings of the communication device 102. For example, the first profile may be received from the server 104 or the database 106. The first profile may be configured to control the communication device 102. For example, when a customer arrives to a showroom (e.g., at the predefined location 112A) to purchase the communication device 102, a dealer or seller may demonstrate certain key features of the communication device 102. The first set of features or settings may be such features or settings that may correspond to key differentiators or unique selling propositions (USPs) of the communication device 102 and the dealer, or seller may wish to demonstrate such features or settings to the customer. The first set of features or settings may be included in the first profile, and the dealer or seller may configure the communication device 102 based on the first profile to demonstrate each of the first set of features or settings to the customer. Details about the first profile reception or generation are described, for example, in FIG. 4 (at 402).

The communication device 102 may further track, using the location sensor associated with the communication device 102, the location of the communication device 102. The location sensor may track the location of the communication device 102 continuously or when the communication device 102 moves from the predefined location 112A. The communication device 102 may further determine whether the communication device 102 is beyond the predefined distance 116 of the predefined location 112A based on the tracked location of the communication device 102. The predefined location 112A may be a shop, a showroom, or the like, of the dealer or the seller. The predefined distance 116 may correspond to a geofence area associated with a region (e.g., the predefined region 114) around the predefined location 112A. The dealer or seller may wish that the communication device 102 remains within the predefined distance 116, before the communication device 102 is sold off. Details about the tracking of the location of the communication device 102 are described, for example, in FIG. 4 (at 404 and 406).

The communication device 102 may further receive ownership update information indicative of an event of an ownership change associated with the communication device 102. For example, the server 104 and/or the database 106 may maintain a status of ownership of the communication device 102 as the ownership information 110 in the database 106. Once the ownership information 110 is updated, the server 104 or the database 106 may transmit the updated ownership information 110 to the communication device 102. The updated ownership information 110 may contain information pertaining to the change of ownership of the communication device 102. Initially, the communication device 102 may be owned by the dealer or the seller. However, when the customer purchases the communication device 102, the ownership of the communication device 102 may be transferred from the dealer or the seller to the customer. Details about the ownership update information are described, for example, in FIG. 4 (at 408).

The communication device 102 may further remove the first profile from the communication device 102, based on the determination that the tracked location is beyond the predefined distance 116 and the received ownership update information (e.g., an updated version of the ownership information 110). As discussed, the first profile may be used by the dealer or the seller of the communication device 102 to persuade the customer to purchase the communication device 102. Once, the communication device 102 is purchased, the first profile may no longer be needed. Thus, once the user purchases the communication device 102 and the communication device 102 moves beyond the predefined distance 116 (which may correspond to the geo-fence associated with the shop or showroom), the communication device 102 may automatically remove the first profile from the communication device 102. Details about the removal of the first profile are described, for example, in FIG. 4 (at 410).

FIG. 2 is a block diagram of an exemplary communication device of FIG. 1, in accordance with an embodiment of the disclosure. FIG. 2 is explained in conjunction with elements from FIG. 1. With reference to FIG. 2, there is shown a block diagram 200 of the communication device 102. The communication device 102 may include circuitry 202, a memory 204, a network interface 206, an input/output (I/O) device 208 comprising a display 208A, and a location sensor 210. Although in FIG. 2, it is shown that the communication device 102 includes the circuitry 202, the memory 204, the network interface 206, the input/output (I/O) device 208, and the location sensor 210; however, the disclosure may not be so limiting, and the communication device 102 may include less or more components to perform the same or other functions of the communication device 102. Details of the other functions or components have been omitted from the disclosure for the sake of brevity.

The circuitry 202 may include suitable logic, circuitry, and interfaces that may be configured to execute program instructions associated with different operations. For example, the operations may include, but are not limited to, first profile reception or generation, location tracking, comparison of the tracked location, reception of the updated ownership information, and removal of the first profile. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, and interfaces that may be configured to store the one or more instructions to be executed by the circuitry 202. The one or more stored instructions may be executable by the circuitry 202 to perform the operations of the circuitry 202 (or the communication device 102). The memory 204 may be configured to store the ownership information 110 (or the updated ownership information 110). The memory 204 may be further configured to store the first profile and information related to, for example, the current tracked location of the communication device 102, information about the predefined location 112A, and information about the predefined distance 116. The memory 204 may be a persistent storage medium, a non-persistent storage medium, or a combination thereof. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, circuitry, and interfaces that may be configured to facilitate communication between the circuitry 202, the server 104 and the communication device 102, via the communication network 108. The network interface 206 may be implemented by use of various known technologies to support wired or wireless communication of the communication device 102 with the communication network 108. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 206 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The input/output (I/O) device 208 may include suitable logic, circuitry, and interfaces that may be configured to receive an input from the user (such as, the user 118) and provide an output based on the received input. For example, the I/O device 208 may receive a user input indicative of a selection of the first profile to control the communication device 102. The I/O device 208 may display information associated with the first profile. In certain cases, the I/O device 208 may further receive a user input for a removal of the first profile from the communication device 102. The I/O device 208 may further display the ownership information 110. The I/O device 208 may further display an indication of a removal of the first profile from the communication device 102. The I/O device 208 which may include various input and output devices, may be configured to communicate with the circuitry 202. Examples of the I/O device 208 may include, but are not limited to, a touch screen, a keyboard, a mouse, a joystick, a microphone, a display device, and a speaker.

The display 208A may include suitable logic, circuitry, and interfaces that may be configured to display ownership update information (e.g., the updated ownership information 110). The display 208A may be a touch screen which may enable a user to provide a user-input via the display 208A. The touch screen may be at least one of a resistive touch screen, a capacitive touch screen, or a thermal touch screen. The display 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display 208A may refer to a display screen of the in-vehicle infotainment (IVI) system, the in-car entertainment (ICE) system, the smartphone, the computer workstation, the handheld computer, the cellular/mobile phone, the portable consumer electronic (CE) device, a smart-glass device, a see-through display, a projection-based display, an electro-chromic display, or a transparent display.

The location sensor 210 may include suitable logic, circuitry, and/or interfaces that may be configured to determine a current geo-location of the communication device 102. The location sensor 210 may be further configured to track the communication device 102. Examples of the location sensor 210, may include, but are not limited to, a Global Navigation Satellite System (GNSS)-based sensor of the communication device 102. Examples of the GNSS-based sensor may include, but are not limited to, global positioning sensor (GPS), Global Navigation Satellite System (GLONASS), or other regional navigation systems or sensors.

In an embodiment, the communication device 102 may be a vehicle or integrated in the vehicle. The vehicle may be a non-autonomous vehicle, a semi-autonomous vehicle, or a fully autonomous vehicle, for example, as defined by National Highway Traffic Safety Administration (NHTSA). Examples of the vehicle may include, but are not limited to, a two-wheeler vehicle, a three-wheeler vehicle, a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle may be a system through which a rider may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell based car, a solar powered-car, or a hybrid car. The present disclosure may be also applicable to other types of two-wheelers (e.g., a scooter) or four-wheelers. The description of other types of the vehicle has been omitted from the disclosure for the sake of brevity.

In accordance with an embodiment, the vehicle may be a micro-mobility vehicle. The micro-mobility vehicle may be used mostly for short distance as it may offer a relatively low mileage because of battery size. The micro-mobility vehicle may be relevant for traveling short distances at a low cost in comparison to cost associated with conventional travel options. In accordance with an embodiment, the micro-mobility vehicle may be compactable and may include certain components that may fold over, slide over other components, retract inside a space, and/or be detached from support members of the micro-mobility vehicle. When not being used, the micro-mobility vehicle may be disposed in a compacted state to allow the user 118 to easily carry and store the vehicle in the compacted state. To operate the vehicle, the user 118 may simply uncompact the micro-mobility vehicle. For example, components, such as handlebar, seats, and wheels may have to be extended from a retracted state. The micro-mobility vehicle may include suitable a propulsion system, a driving mechanism, and an energy source(s) that may allow the user 118 to ride the micro-mobility vehicle for a limited distance. Examples of micro-mobility vehicles may include, but are not limited to, an e-kick scooter, an electric scooter, an electric unicycle, an electric cycle, an electric hover board, an electric skateboard, and an electric roller skate.

Apart from the circuitry 202, the memory 204, the I/O device 208, the network interface 206, and the location sensor 210, the vehicle may include an engine, a battery, a power system, a steering system, a braking system, and an HVAC system. However, the disclosure may not be so limiting, and the vehicle may include less or more components to perform the same or other functions of the vehicle. Details of the other functions or components have been omitted from the disclosure for the sake of brevity. The engine, the battery, the power system, the steering system, the braking system, and the HVAC system, though not shown in FIG. 2, are described herein.

The engine may be configured to provide power to the vehicle. The engine may be an internal combustion engine with may include operations, for example, fuel injection, compression, ignition, or emission to power and drive the vehicle. The engine may include various parts, for example, but are not limited to, a crankshaft, a cylinder, a spark plug, a piston, camshaft, a valve, combustion chamber, etc. In some embodiments, the engine may include a motor in case of an electric motorcycle. The engine may be two-stroke or four-stroke internal combustion engines. The engine may include either one, two, three, four, or six cylinders. Examples of the engine may include, but are not limited to, an inline engine (i.e., single cylinder, parallel twin, inline-triple, inline-four, inline-six), a V layout engine (i.e., V-twin engine, a V4 engine, a V8 engine), a flat (boxer) engine (i.e., flat-two, flat-four, flat-six), a lawn mower engine, a snow blower engine, or other motorcycle engines known in the art. A description of various parts of the engine has been omitted from the disclosure for the sake of brevity.

The battery may be a source of electric power for one or more electric circuits or loads (not shown). For example, the battery may be a source of an electrical power to a control circuitry (for example, the circuitry 202) of the vehicle, the memory 204, the network interface 206, the I/O device 208, the engine, the power system, the steering system, and the braking system. The battery may be a rechargeable battery. The battery may be the source of an electrical power to start the engine of the vehicle. In some embodiments, the battery may correspond to a battery pack, which may have a plurality of clusters of batteries, which may be surrounded by a suitable coolant and a charge controller. Examples of the battery may include, but are not limited to, a lead acid battery, a nickel cadmium battery, a nickel-metal hydride battery, a lithium-ion battery, and other rechargeable batteries.

The power system may include suitable logic, circuitry, interfaces, and/or code that may be configured to control electric power which may be output to various electric circuits and loads of the vehicle. The power system may include a battery (not shown) to provide the electric power to perform various electrical operations of the vehicle. The power system may provide the electric power for functioning of different components (such as, an electronic control device, a communication system, the memory 204, the steering system, and a plurality of sensors (such as, the location sensor 210)) of the vehicle. The power system may be configured to receive control signals from a processor (such as, the circuitry 202) to control the electronic control device, the communication system, the memory, the steering system, and the plurality of sensors of the vehicle. The power system may be configured to control the charging and the discharging of the battery and an auxiliary battery based on the received control signals. The power system may be configured to control the transfer of the electric energy between the power system and the communication system, the memory 204, the steering system, and the plurality of sensors, of the vehicle. Examples of the power system may include, but are not limited to, an electric charge/discharge controller, a charge regulator, a battery regulator, a battery management system, an electric circuit breaker, a power electronic drive control system, an Application-Specific Integrated Circuit (ASIC) processor, and/or other energy-control hardware processors.

The steering system may receive one or more control commands from the user 118. The steering system may include a steering wheel/handlebar and/or an electric motor (provided for a power-assisted steering) that may be used by a driver to control movement of the vehicle in manual mode or a semi-autonomous mode. In accordance with an embodiment, the movement or steering of the vehicle may be automatically controlled when the vehicle is in autonomous mode. Examples of the steering system may include, but are not limited to, an autonomous steering control, a power-assisted steering system, a vacuum/hydraulic-based steering system, an electro-hydraulic power-assisted system (EHPAS), or a “steer-by-wire” system, or an autonomous steering system, known in the art.

The braking system may be used to stop or slow down the vehicle by application of resistive forces, such as electromagnetic and/or frictional forces. The braking system may receive a command from a powertrain control system under the control of a control circuitry when the vehicle is in an autonomous mode or a semi-autonomous mode. In accordance with an embodiment, the braking system may receive a command from the control circuitry when the control circuitry preemptively detects intent of the user 118 to perform a specific task which requires the user 118 to apply brakes.

The HVAC system may include a heating system, a ventilation system, an air-conditioning system, and/or a thermostat system that may be configured to maintain a temperature, an air flow, and/or a humidity level of air inside a cabin of the vehicle. The HVAC system may include a set of adjustable air vents that may be servo-controlled (e.g., controlled by one or more servo motors). The set of adjustable air vents may circulate air at a certain temperature, humidity, and pressure to the cabin of the vehicle to maintain the temperature, air flow, and/or humidity level of the air inside the cabin of the vehicle.

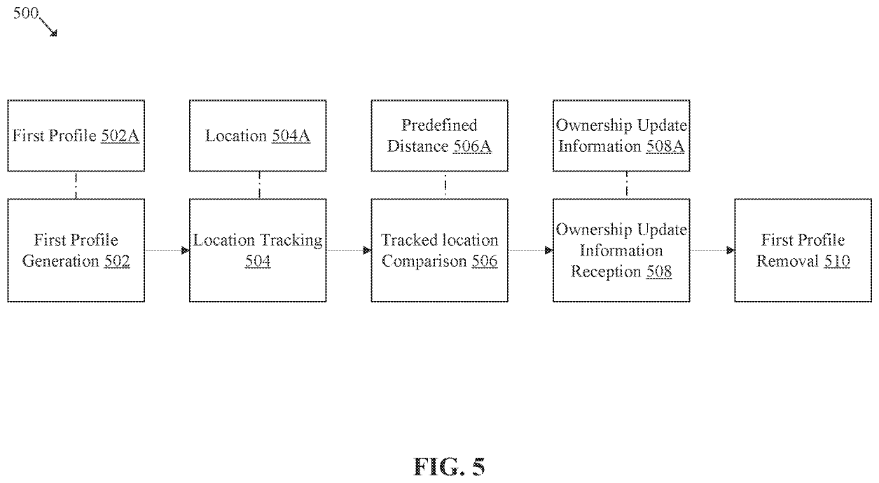

The functions or operations executed by the communication device 102, as described in FIG. 1, may be performed by the circuitry 202. Operations executed by the circuitry 202 are described in detail, for example, in FIG. 5.

FIG. 3 is a block diagram of an exemplary server, in accordance with an embodiment of the disclosure. FIG. 3 is explained in conjunction with elements from FIGS. 1 and 2. With reference to FIG. 3, there is shown a block diagram 300 of the server 104. The server 104 may include a circuitry 302, a memory 304, a network interface 306, an input/output (I/O) device 308 comprising a display 308A, and a location sensor 310. Although in FIG. 3, it is shown that the server 104 includes the circuitry 302, the memory 304, the network interface 306, the input/output (I/O) device 308, and the location sensor 310; however, the disclosure may not be so limiting, and the server 104 may include less or more components to perform the same or other functions of the server 104. Details of the other functions or components have been omitted from the disclosure for the sake of brevity.

In FIG. 3, there is further shown, a set of communication devices 312 including, for example, a first communication device 312A, a second communication device 312B, . . . and an Nth communication device 312N. Each of the set of communication devices 312 may be connected with the server 104, via the communication network 108. The functions of each of the set of communication devices 312 may be same as the functions of the communication device 102 described, for example, in FIG. 2. Therefore, the description of the set of communication devices 312 is omitted from the disclosure for the sake of brevity. The N number of communication devices in the set of communication devices 312 shown in FIG. 3 is presented merely as an example. The set of communication devices 312 may include only one or more than N communication devices, without deviation from the scope of the disclosure. For the sake of brevity, only N communication devices have been shown in FIG. 3. However, in some embodiments, there may be more than N communication devices, without limiting the scope of the disclosure.

The circuitry 302 may include suitable logic, circuitry, and interfaces that may be configured to execute program instructions associated with different operations of the server 104. The operations executed by the server 104 may include, but are not limited to, first profile reception or generation, location tracking, comparison of the tracked location to the predefined location 112A, ownership update information reception, and first profile removal. The circuitry 302 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 302 may be implemented based on a number of processor technologies known in the art. Examples of implementations of the circuitry 302 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 304 may include suitable logic, circuitry, and interfaces that may be configured to store the one or more instructions to be executed by the circuitry 302. The one or more instructions stored in the memory 304 may be executed by the circuitry 302 to perform the operations of the server 104. The memory 304 may be configured to store the updated ownership information (e.g., the ownership information 110). The memory 304 may be further configured to store the first profile and information related to, for example, the current tracked location of the communication device 102, the predefined location 112A, and the predefined distance 116.

The functions of the memory 304, the network interface 306, the I/O device 308, and the display 308A may be same as the functions of the memory 204, the network interface 206, the I/O device 208, and the display 208A, respectively, described, for example, in FIG. 2. Therefore, the description of the memory 304, the network interface 306, the I/O device 308, and the display 308A is omitted from the disclosure for the sake of brevity.

The location sensor 310 may include suitable logic, circuitry, and/or interfaces that may be configured to determine a current geo-location of the server 104. For example, the location sensor 310 may determine the predefined location 112A of the server 104. Examples of the location sensor 310, may include, but are not limited to, a Global Navigation Satellite System (GNSS)-based sensor of the server 104. Examples of the GNSS-based sensor may include, but are not limited to, global positioning sensor (GPS), Global Navigation Satellite System (GLONASS), or other regional navigation systems or sensors.

The functions or operations executed by the server 104, as described in FIG. 1, may be performed by the circuitry 302. Operations executed by the circuitry 302 are described in detail, for example, in FIG. 5.

FIG. 4 is a diagram that illustrates an exemplary processing flow for automatic profile configuration by a communication device, based on location and ownership change of the communication device, in accordance with an embodiment of the disclosure. FIG. 4 is explained in conjunction with elements from FIG. 1, FIG. 2, and FIG. 3. With reference to FIG. 4, there is shown an exemplary processing flow 400 that illustrates exemplary operations from 402 to 414 for automatic profile configuration. The exemplary operations 402 to 414 may be executed by any computing system, for example, by the communication device 102 of FIG. 1 or by the circuitry 202 of FIG. 2. The exemplary processing flow 400 further illustrates a first profile 402A, a location 404A, a predefined distance 406A, ownership update information 408A, and a second profile 414A.

At 402, an operation for a first profile reception may be executed. The circuitry 202 may be configured to receive, from a server (e.g., the server 104) a first profile (for e.g., the first profile 402A) including a first set of features or settings of the communication device 102. The received first profile 402A may be configured to control the communication device 102. For example, if a customer (e.g., the user 118) arrives at a showroom or shop that sells or displays the communication device 102, a dealer or seller may demonstrate certain key features of the communication device 102. In an example, the showroom or shop may be located at the predefined location 112A. Further, the server 104 may be associated with the showroom or the shop. The first set of features or settings may be such features or settings that may correspond to key differentiators or unique selling propositions (USPs) of the communication device 102, and the dealer or seller may wish to demonstrate such features or settings to the customer. The first set of features or settings may be included in the first profile 402A and the dealer or seller may configure the communication device 102, based on the first profile 402A to demonstrate each of the first set of features or settings to the customer.

In an embodiment, the first profile 402A may include information related to at least one of, but not limited to, social applications, streaming services, Radio Detection and Ranging (RADAR) features, preloaded destinations, test drives, temperature settings, Heating Ventilation and Air-Conditioning (HVAC) settings, infotainment features, or tutorials associated with systems of the communication device 102. For example, the social applications may be applications that the user 118 may use to connect with others virtually. Due to an increase in, a user-base of social applications, the user 118 may wish to see whether the communication device 102 includes the social application or not. Hence, the social application may be included in the first profile 402A. The streaming services may be considered as an entertainment or media streaming application that may be used to watch various videos, listen to audio like songs, and the like.

In case the communication device 102 is a vehicle, the preloaded destinations may be destinations such as, service centers, fuel pumps, nearby entertainment locations, nearby health care centers, nearby restaurants, and the likes, that the vehicle may be driven to. The preloaded destinations may enable driver such as, the user 118, to select any of the preloaded destination to obtain a route of the vehicle from its current location to the preloaded destination. As owners of the vehicle may often travel to and from certain locations, such as, home, office, gym, and the like, the preloaded destination feature may be demonstrated to the customer as a useful feature, which may encourage the customer to purchase the vehicle. The preloaded destination feature may further increase an interest of the customer in the vehicle. It may be noted that often customers of a vehicle may wish to go for a test drive. The test drive feature may include one or more predefined routes that the customer may take for a test drive. Further, the test drive feature may include a time duration for which the vehicle may be driven for the test drive. The RADAR feature may help to detect objects at a certain distance around the communication device 102 (such as, a vehicle). The RADAR feature may also help to determine a distance of the detected object from the communication device 102, a velocity of approach of the object. The temperature settings may be used to set a temperature of, for example, a cabin of the vehicle. The temperature settings may include an ambient temperature, a cooling button, a heating button, an airflow, a humidity control setting, and the like. The dealer may demonstrate the temperature settings to explain the customer as to how the temperature of the cabin of the vehicle may be controlled. The tutorials associated with an infotainment system of the communication device 102 may include one or more audio or video recordings or textual information that may be rendered/shown to the customer in order to give an insight as to how to operate the infotainment system. The tutorials may also explain other features of the communication device 102. For example, the tutorials may provide battery specifications, engine specifications, HVAC specifications, display specifications, refresh rate, processor specifications, and the like.

In an embodiment, the communication device 102 may be at least one of, but not limited to, a vehicle, a mobility device, a mobile device, a consumer electronic device with an associated location sensor, or a computing device with an associated location sensor. As discussed, the vehicle may be a non-autonomous vehicle, a semi-autonomous vehicle, or a fully autonomous vehicle. The mobility device may include devices such as, but not limited to, micro-mobility devices, bicycles, walking aids, and the like. The mobile device may include, but is not limited to, cell phones, mobile phones, and the like, that may be used by the user such as, the user 118, to communicate with others. The consumer electronic device with the associated location sensor may correspond to various electronic devices that may be used by people. Examples of the consumer electronic device may include, but are not limited to, televisions, media players, music or audio systems, hi-fi stereo, home theater, and the like. The consumer electronic device of the present disclosure may be associated with the location sensor to track a location of the consumer electronic device. The computing device with the associated location sensor may include devices such as, but not limited to, laptops, palmtops, computers, mobile phones, and the like, that may perform one or more general-purpose computing functions. The computing device of the present disclosure may be associated with the location sensor to track a location of the computing device.

At 404, an operation for a location tracking may be executed. The circuitry 202 may be configured to track, using the location sensor 210 associated with the communication device 102, a location (e.g., the location 404A) of the communication device 102. In an embodiment, the location sensor 210 may track the location of the communication device 102 continuously. In another embodiment, the location sensor 210 may track the location of the communication device 102 after some predefined time duration. In yet another embodiment, the location sensor 210 may track the location 404A of the communication device 102 when the communication device 102 moves from the predefined location (such as, the predefined location 112A of FIG. 1).

At 406, an operation for a tracked location comparison may be executed. The circuitry 202 may be configured to execute the tracked location comparison. For the tracked location comparison, the circuitry 202 may be configured to determine whether the communication device 102 is beyond a predefined distance (e.g., the predefined distance 406A) of the predefined location 112A, based on the tracked location (e.g., the location 404A) of the communication device 102. The predefined location 112A may be a location of the dealer or the seller, such as, a location of the shop, the showroom, and the like, associated with the communication device 102 or the location of the server 104 associated with the dealer or the seller. For example, the dealer or seller may keep the unsold communication device 102 at the predefined location 112A and/or within the predefined region 114. The predefined region 114 may be an area whose boundaries may lie at the predefined distance 406A from the predefined location 112A. For example, the predefined region 114 may be a circle with the predefined location 112A as its center and the predefined distance 406A as its radius.

Typically, before a purchase of a device by a customer, the customer may not move the device beyond the predefined distance 406A from the predefined location 112A. For example, if the communication device 102 is a mobile device, then the mobile device may be kept in an electronics shop until the mobile device is purchased. In such case, the predefined distance 406A may be a boundary of the electronics shop. Similarly, if the communication device 102 is a vehicle, then the vehicle may be kept in a showroom or within a certain geo-fence (i.e., a tracked area) around the showroom, until the vehicle is purchased. The circuitry 202 may compare the tracked location (e.g., the location 404A) of the communication device 102 with the predefined location 112A of the server 104 to determine if the location 404A is beyond the predefined distance 406A from the predefined location 112A or not. In an embodiment, the tracked location (e.g., the location 404A) may be compared continuously to determine whether the communication device 102 is within the predefined distance 406A of the predefined location 112A. In another embodiment, the tracked location (e.g., the location 404A) may be compared periodically after at an end of a certain time interval (such as, one minute), to determine whether the communication device 102 is within the predefined distance 406A of the predefined location 112A. In yet another embodiment, the tracked location (e.g., the location 404A) may be compared after the communication device 102 moves from the predefined location 112A.

In an embodiment, the communication device 102 may correspond to a vehicle, and the predefined distance 406A from the predefined location 112A may correspond to an area within which the vehicle is to be driven for a test drive. For example, a customer (such as, the user 118) may want to go on test drive in the vehicle to evaluate a driving experience associated with the vehicle. The dealer may allow the customer to go on the test drive within the predefined distance 406A (i.e., within the predefined region 114). For example, the customer may drive the vehicle for the test drive within a 5 kilometers radius of the showroom. The customer may take the vehicle beyond the 5 kilometers radius only when the customer purchases the vehicle. In such case, the predefined location 112A may be the location of the showroom and the predefined distance 406A may be for example, a circle of 5 kilometers radius around the showroom.

In an embodiment, the circuitry 202 may be further configured to transmit a notification indicative of an instruction to return the communication device 102 to the predefined location 112A. The instruction may be transmitted based on the determination that the tracked location (e.g., the location 404A) of the communication device 102 is beyond the predefined distance 406A of the predefined location 112A. In an example, the communication device 102 may be a mobile device. The customer may move the mobile device within a premises of an electronics shop. However, in case the customer takes the mobile device outside the electronics shop, the notification may be sent to return the mobile device to the electronics shop. In such case, the notification may be in a form of a vibration of the mobile device, a notification message displayed on the mobile device, an activation of a sound alarm on the mobile device, and the like. In another example, the communication device 102 may be a vehicle and a customer may take the vehicle for a test drive. The predefined location 112A may be a location of a showroom of the vehicle and the predefined distance 406A may correspond to five kilometers around the predefined location 112A. In case the customer takes the vehicle for the test drive beyond the five kilometers radius of the predefined location 112A, a notification, such as, “Please return to showroom”, may be displayed on a display (such as, the display 208A of FIG. 2) of the communication device 102. In some cases, the alarm of the vehicle may be executed to notify the customer to return the communication device 102 (i.e., for which purchase is still not completed) to the predefined location 112A (i.e., the location of the showroom).

At 408, an operation for an ownership update information reception may be executed. The circuitry 202 may be configured to receive an ownership update information (e.g., the ownership update information 408A) indicative of the event of an ownership change associated with the communication device 102. The ownership update information 408A may include information pertaining to a change of an ownership of the communication device 102. For example, the ownership update information 408A may correspond to an updated version of the ownership information 110, which may be updated based on the change of the ownership of the communication device 102. Initially, the communication device 102 may be owned by the dealer or the seller of the communication device 102. However, when a customer purchases the communication device 102, the ownership of the communication device 102 may be transferred from the dealer or the seller to the customer. For example, once the customer purchases the communication device 102, a message may be transmitted to a computing device or a server (e.g., the server 104) of a back office (associated with the dealer or the seller). The message may indicate that the communication device 102 is sold. The message may also include identification and address details associated with the customer, payment details, sale transaction details, guarantee information, and other information. In an embodiment, the message may be transmitted by the communication device 102 or the server 104. The back office (or associated device/server) may verify the message and authorize an ownership update in a favor of the customer based on the verification of the message. Thereafter, the back office (or associated device/server) may transmit the ownership update information 408A to the communication device 102 to indicate of the event of the ownership change associated with the communication device 102.

In an embodiment, the ownership update information 408A may include one or more of, but not limited to, identification information of the communication device 102, a name of a user (e.g., the user 118) associated with the communication device 102, an address of the user, contact information of the user, and payment details associated with the ownership update information 408A of the communication device 102. The identification information of the communication device 102 may include a unique identification number or code associated with the communication device 102. For example, if the communication device 102 is a mobile device, then the identification information may be international mobile equipment identity (IMEI) of the mobile device. Similarly, if the communication device 102 is a vehicle, then the identification information may be a vehicle identification number (VIN) of the vehicle. The identification information of the communication device 102 may ensure that ownership details of the correct communication device 102 are updated. The name of the user associated with the communication device 102 may be a name of a new user/owner and/or a current user/owner of the communication device 102. The name of the user may be required to transfer the ownership of the communication device 102 to the user. The address of the user may include, a home address, an office address, a permanent address, and the like, of the user. Contact information of the user may include a phone number and an email address. The payment details may include an amount that may be paid by the customer (such as, the user 118 of FIG. 1) associated with of the communication device 102, a pending amount to be paid by the user, a mode of payment (such as, cash, card, online payments, and the like) made by the user. The identification information of the communication device 102, the name of the user associated with the communication device 102, the address of the user, and/or the payment details may be used to change the ownership of the communication device 102 from the dealer to the user.

In an embodiment, in addition to the transmission of the notification when the tracked location (e.g., the location 404A) of the communication device 102 is beyond the predefined distance 406A of the predefined location 112A, the notification may be further transmitted based on whether the communication device 102 (e.g., a vehicle) has been purchased by the user 118. For example, based on the reception of the ownership update information 408A, the circuitry 202 may determine whether the vehicle has been purchased by the user 118. In case the vehicle has not yet been bought by the user 118 and the tracked location of the vehicle is determined to be beyond the predefined distance 406A (e.g., a geo-fence associated with a showroom of the vehicle) of the predefined location 112A (e.g., the showroom of the vehicle), the circuitry 202 may transmit the notification. Details related to the transmission of the notification are described further, for example, at 406.

At 410, an operation for a first profile removal may be executed. The circuitry 202 may be configured to remove the first profile 402A from the communication device 102, based on the determination that the tracked location (e.g., the location 404A) is beyond the predefined distance 406A and the received ownership update information 408A. As discussed, the first profile 402A may be configured on the communication device 102 by the dealer or seller of the communication device 102 to persuade the customer (e.g., the user 118) to purchase the communication device 102. In an embodiment, the first profile 402A may indicate default or factory setup features or settings of the communication device 102. Once, the communication device 102 is purchased, the customer may want to remove the first profile 402A from the communication device 102 and re-configure the communication device 102 as per the customer's preferences. As discussed, the customer may be allowed to move the communication device 102 beyond the predefined distance 406A after the purchase of the communication device 102. Once, the customer purchases the communication device 102, the ownership of the communication device 102 may be changed to the customer, as may be indicated by the received ownership update information 408A. Thus, the communication device 102 may automatically remove the first profile 402A from the communication device 102 if the location 404A is determined to be beyond the predefined distance 406A from the predefined location 112A, and further if the received ownership update information 408A indicates that the customer has bought the communication device 102. For example, the communication device 102 is a vehicle and the ownership update information 408A indicates that the communication device 102 is sold to the customer. In such case, when the customer drives the vehicle beyond the predefined distance 406A and moves outside the predefined region 114, the circuitry 202 may automatically remove the first profile 402A from the communication device 102.

In an embodiment, the circuitry 202 may be further configured to remove the first profile 402A from the communication device 102, based on at least one of, but not limited to, a sign off from the first profile 402A, a disablement of the first profile 402A, or a reset of the settings or features of the electronic device to a pre-set state. The sign off from the first profile 402A may correspond to a manual or automated sign out from the first profile 402A. The sign out may be triggered by an application on the communication device 102, based on a user input, which may be received from a user, such as, the dealer or the seller of the communication device 102. The disablement of the first profile 402A may disable the first profile 402A from the communication device 102, such that the disabled first profile 402A may not be used by the user 118. In an embodiment, the disabled first profile 402A may be re-enabled on the communication device 102 by the dealer or the seller. For example, in certain cases, the disabled first profile 402A may still be stored in the memory 204 and may be accessible only to the dealer or the seller. In another scenario, the disablement of the first profile 402A may correspond to a deletion of the first profile 402A from the communication device 102, wherein the memory 204 may store identification information of the first profile 402A. Based on the identification information of the first profile 402A, the first profile 402A may be queried and received from the database 106 or the server 104, based on a request from the dealer or seller, if required. The reset of the settings or features of the communication device 102 to the pre-set state may factory reset the communication device 102. The pre-set state may be state of the communication device 102 before the dealer or the seller initially started the communication device 102 for the configuration of the first profile 402A.

In an embodiment, the circuitry 202 may be configured to start a timer on the communication device 102, based on a movement of the communication device 102 from the predefined location 112A of the server 104. For example, the circuitry 202 may start a clock timer (not shown) that may count seconds or minutes from the determination of the movement of the communication device 102 from the predefined location 112A. The circuitry 202 may be further configured to compare a value of the started timer with a preset time duration (for example, 15 minutes). The preset time duration may be a maximum time duration for which the customer may move the communication device 102 from the predefined location (such as, the predefined location 112A) without a purchase or ownership change attributable to the customer. The preset time duration may be set by the dealer or the seller.

The circuitry 202 may be further configured to determine whether the value of the started timer exceeds the preset time duration, based on the comparison. The value of the started timer may be compared with the preset time duration continuously, after regular intervals, or when requested by the dealer or the seller to make comparison. The circuitry 202 may be configured to remove the first profile 402A from the communication device 102 further based on the determination that the value of the started timer value exceeds the preset time duration. In an example, in case the timer value exceeds the preset time duration of, for example, 15 minutes, the circuitry 202 may delete the first profile 402A from the communication device 102. Thus, the communication device 102 may retain the first profile 402A only till the preset time duration passes from the departure of the communication device 102 from the predefined location 112A (e.g., the location of the showroom).

For example, the customer may be allowed to move the communication device 102 from the predefined location 112A for only the preset time duration before the purchase of the communication device 102 or before the change of ownership of the communication device 102 to the customer. The customer may move the communication device 102 from the predefined location 112A beyond the preset time duration only when the ownership of the communication device 102 is transferred to the customer or when the customer has purchased the communication device 102. Then, if the value of the started timer is greater than the pre-set time duration, the first profile 402A (which is associated with the dealer or seller) may be automatically removed. For example, if the communication device 102 is a vehicle, then the dealer may set the preset time duration for which the customer may take the vehicle for the test drive. The timer may be started from an instant at which the vehicle is moved from the predefined location (such as, the predefined location 112A). In case the vehicle has not yet returned to the predefined location 112A (e.g., the showroom), the preset time duration has expired, and the vehicle is not yet been purchased (i.e., based on an ownership change) by the customer, the customer may be prompted (through a notification on the display 208A) to return the vehicle to the predefined location 112A (i.e., the showroom). The display of such notification may ensure that the communication device 102 is returned to the predefined location 112A (e.g., the showroom or shop) within a certain time if the purchase of the communication device 102 has not concluded with the user 118. Beyond the preset time duration, the customer may drive the vehicle only when the ownership of the vehicle has been transferred to the customer or the vehicle has been purchased by the customer. Then, the first profile 402A may be automatically removed from the vehicle once the customer drives beyond the preset time duration.

At 412, an operation for a user input reception may be executed. The circuitry 202 may be further configured to receive, from the user (e.g., the user 118), a user input including information indicative of a second set of features or settings of the communication device 102. As discussed, once the ownership update information 408A is received and the tracked location (e.g., the location 404A) is beyond the predefined distance 406A, then the first profile 402A may be removed from the communication device 102. The user may wish to create another personalized profile according to the user's preference. The second set of features or settings may be features or settings that may be selected by the user according to the user's preference.

In an embodiment, the user input may be received based on the received ownership update information 408A. In case the ownership update information 408A is received, then the communication device 102 may prompt the user to provide the user input including information indicative of the second set of features or settings of the communication device 102. In an embodiment, a user interface including a set of user interface (UI) elements may be provided on the display 208A. The user may select one or more of the set of UI elements to provide the user input. For example, the user may provide one or more destinations such as, home, office, and the like, that the user may frequently travel to and from, a personalized temperature that the user wishes to maintain of the cabin of the vehicle, and the like.

At 414, an operation for a second profile generation may be executed. The circuitry 202 may further configured to generate the second profile 414A associated with a user (e.g., the user 118), based on the received user input. For example, the user 118 may provide one or more destinations, such as, a home location “A” and an office location “B” that the user may frequently travel to and from, as the user input. Further, the user may provide a personalized temperature, such as, 25 degrees Celsius, that the user wishes to maintain in a cabin of the vehicle. In such case, the generated second profile 414A may include the location “A”, the location “B”, and the personalized temperature. In an embodiment, the generated second profile 414A may include information related to at least one of, but not limited to, social applications, streaming services, Radio Detection and Ranging (RADAR) features, preloaded destinations, test drives, temperature settings, Heating Ventilation and Air-Conditioning (HVAC) settings, or tutorials associated with the infotainment system of the communication device 102.

In an embodiment, the first profile 402A may be removed from the communication device 102 further based on the generated second profile 414A. Once, the second profile 414A is generated, the first profile 402A may be automatically removed from the communication device 102. For example, once the second profile 414A is generated based on the user input, the first profile 402A may be signed off and/or removed from the communication device 102. The generated second profile 414A may be configured to control the communication device 102 based on the removal of the first profile 402A from the communication device 102. In another embodiment, the communication device 102 may provide UI elements (not shown) on the display 208A for removal of the first profile 402A manually. For example, a first UI element such as, a delete button, may be provided on the user interface on the display 208A. The user 118 may select the delete button to delete the first profile 402A. Similarly, a second UI element such as, a sign off button, may be provided that may be selected by the user 118 to sign out the first profile 402A.

FIG. 5 is a diagram that illustrates an exemplary processing flow for automatic profile configuration by a server based on location and ownership change of a communication device associated with the server, in accordance with an embodiment of the disclosure. FIG. 5 is explained in conjunction with elements from FIG. 1, FIG. 2, FIG. 3, and FIG. 4. With reference to FIG. 5, there is shown an exemplary processing flow 500 that illustrates exemplary operations from 502 to 510 for automatic profile configuration. The exemplary operations 502 to 510 may be executed by any computing system, for example, by the server 104 of FIG. 1 or by the circuitry 302 of FIG. 3. The exemplary processing flow 500 further illustrates a first profile 502A, a location 504A, a predefined distance 506A, and ownership update information 508A.

At 502, an operation for a first profile generation may be executed. The circuitry 302 may be configured to generate a first profile (e.g., the first profile 502A) including a first set of features or settings for each communication device (such as, the first communication device 312A) of the set of communication devices 312 (shown in FIG. 3). The generated first profile 502A may be configured to control the corresponding communication device (such as, the first communication device 312A) of the set of communication devices 312. For example, if a customer (e.g., the user 118) arrives at a showroom or shop that sells or displays the first communication device 312A, a dealer or seller may demonstrate certain key features of the first communication device 312A. In an example, the showroom or shop may be located at the predefined location 112A. Further, the server 104 may be associated with the showroom or the shop.

The first set of features or settings may be such features or settings that may correspond to key differentiators or unique selling propositions (USPs) of the set of communication devices 312 and the dealer or seller may wish to demonstrate such features or settings to the customer. The first set of features or settings may be included in the first profile 502A and the dealer or seller may wish to configure the set of communication devices (including, for example, the first communication device 312A), based on the first profile 502A to demonstrate each of the first set of features or settings to the customer. In an embodiment, the first profile 502A may include information related to at least one of, but not limited to, social applications, streaming services, Radio Detection and Ranging (RADAR) features, preloaded destinations, test drives, temperature settings, Heating Ventilation and Air-Conditioning (HVAC) settings, or tutorials associated with an infotainment system of each communication device (such as, the first communication device 312A) of the set of communication devices 312. Once the first profile 502A is generated, the circuitry 302 may transmit the first profile 502A to the database 106 for storage. Further, based on a query received from a communication device (such as, the first communication device 312A) of the set of communication devices 312, the circuitry 302 may transmit the first profile 502A to the communication device. Alternatively, the circuitry 302 may retrieve the first profile 502A from the database 106 and transmit the retrieved first profile 502A to the communication device. As discussed, the first profile 502A may be configured to control the corresponding communication device that receives the first profile 502A. Details related to the first profile are further described, for example, in FIG. 4 (at 402).

At 504, an operation for a location tracking may be executed. The circuitry 302 may be configured to track, using a location sensor associated with each of the set of communication devices 312, a location (e.g., the location 504A) of the corresponding communication device of the set of communication devices 312. For example, the circuitry 302 may use the location sensor 310 to determine a geo-location (such as, the predefined location 112A) of the server 104. Further, the circuitry 302 may receive information associated with a geo-location of each of the set of communication devices 312 (for example, including the first communication device 312A) from the respective communication device of the set of communication devices 312. Each communication device (e.g., the first communication device 312A) of the set of communication devices 312 may use a location sensor (e.g., the location sensor 210) to track the location (e.g., the location 504A) of each corresponding communication device (e.g., the first communication device 312A). Each communication device may then send information associated with the tracked location of the corresponding communication device to the server 104. The server 104 may thereby track the location of each communication device of the set of communication devices 312, by use of the location sensor (e.g., the location sensor 210) of the respective communication device. In an embodiment, the location of each communication device may be tracked continuously. In another embodiment, the location of each communication device may be tracked after some time duration. In another embodiment, the location of each communication device may be tracked when the corresponding communication device moves from the predefined location (such as, the predefined location 112A of FIG. 1).

At 506, an operation for a tracked location comparison may be executed. The circuitry 302 may be configured to execute the tracked location comparison. For the tracked location comparison, the circuitry 302 may be configured to determine whether the corresponding communication device (such as, the first communication device 312A) is beyond a predefined distance (e.g., the predefined distance 506A) of the predefined location 112A, based on the tracked location (e.g., the location 504A) of the communication device 102. The predefined location 112A may be a location of the dealer or the seller, such as, a location of the shop, the showroom, and the like, associated with the corresponding communication device (such as, the first communication device 312A). The dealer or seller may keep the unsold communication device at the predefined location 112A and/or within the predefined region 114. The predefined region 114 may be an area whose boundaries may lie at the predefined distance 406A from the predefined location 112A. For example, the predefined region 114 may be a circle with the predefined location 112A as its center and the predefined distance 406A as its radius. Details related to the tracked location comparison operation are described further, for example, in FIG. 4 (at 406).

At 508, an operation for an ownership update information reception may be executed. The circuitry 302 may be configured to receive an ownership update information (e.g., the ownership update information 508A) indicative of the event of an ownership change associated with the corresponding communication device (such as, the first communication device 312A). The ownership update information 508A may include information pertaining to a change of an ownership of the corresponding communication device of the set of communication devices 312. For example, the ownership update information 508A may correspond to an updated version of the ownership information 110, which may be updated based on the change of the ownership of the corresponding communication device (such as, the first communication device 312A). Initially, a communication device may be owned by the dealer or the seller of the communication device. However, when a customer purchases the communication device, the ownership of the communication device may be transferred from the dealer or the seller to the customer. In an embodiment, the ownership update information 508A may include one or more of, but not limited to, identification information of the communication device 102, a name of a user (e.g., the user 118) associated with the communication device 102, an address of the user, and payment details associated with the ownership update information 508A of the communication device 102. The identification information of the communication device 102 may include a unique identification number or code associated with the communication device 102. Details related to the ownership update information reception are described further, for example, in FIG. 4 (at 408).

At 510, an operation for a first profile removal may be executed. The circuitry 302 may be configured to remove the first profile 502A from the corresponding communication device (such as, the first communication device 312A), based on the determination that the tracked location (e.g., the location 504A) is beyond the predefined distance 506A and the received ownership update information 508A. As discussed, the first profile 502A may be configured on the corresponding communication device by the dealer or seller of the communication device to persuade the customer (e.g., the user 118) to purchase the corresponding communication device. Once, the particular communication device is purchased, the customer may want to remove the first profile from the communication device and re-configure the communication device as per the customer's preferences. For example, the communication device 102 is a vehicle and the ownership update information 508A indicates that the communication device 102 is sold to the customer. In such case, when the customer drives the vehicle beyond the predefined distance 506A and moves outside the predefined region 114, the circuitry 302 may automatically remove the first profile 502A from the communication device 102.

In an embodiment, the circuitry 302 may be configured to start a timer on the corresponding communication device, based on a movement of the particular communication device from the predefined location 112A of the server 104. For example, the circuitry 302 may start a clock timer (not shown) that may count seconds or minutes from the determination of the movement of the corresponding communication device from the predefined location 112A. The circuitry 302 may be further configured to compare a value of the started timer with a preset time duration (for example, 15 minutes). The preset time duration may be a maximum time duration for which the customer may move the communication device from the predefined location (such as, the predefined location 112A) without a purchase or ownership change attributable to the customer. The preset time duration may be set by the dealer or the seller. The circuitry 302 may be further configured to determine whether the value of the started timer exceeds the preset time duration, based on the comparison. The value of the started timer may be compared with the preset time duration continuously, after regular intervals, or when requested by the dealer or the user to make comparison. The circuitry 302 may be configured to remove the received first profile 502A from the corresponding communication device further based on the determination that the value of the started timer value exceeds the preset time duration. Details related to the removal of the first profile from a communication device are described further, for example, in FIG. 4 (at 410). Further, the corresponding communication device may receive a user input and generate a second profile based on the received user input. The reception of the user input and the generation of the second profile are described further, for example, in FIG. 4 (at 412 and 414).

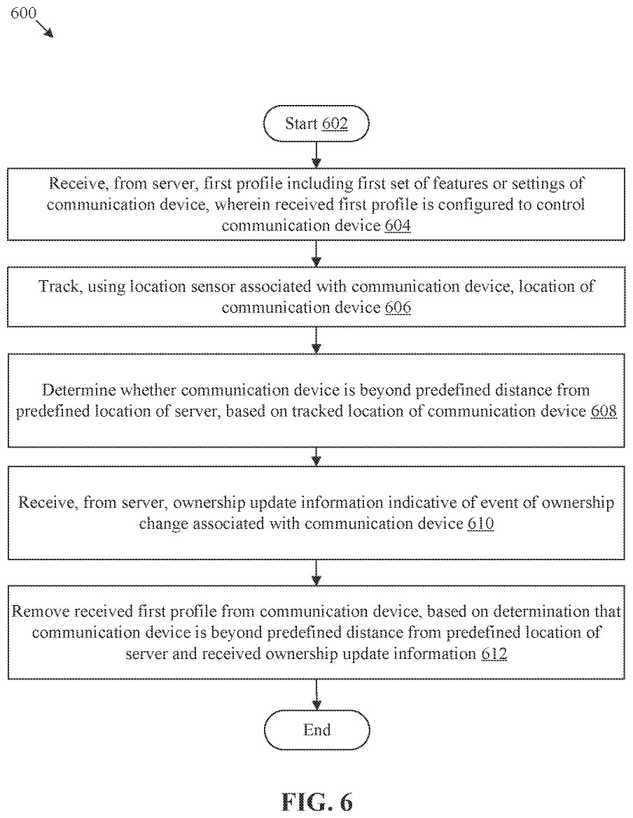

FIG. 6 illustrates a flowchart of an exemplary method for automatic profile configuration by a communication device based on location and ownership change of the communication device, in accordance with an embodiment of the disclosure. With reference to FIG. 6, there is shown a flowchart 600. The flowchart 600 is described in conjunction with elements from FIG. 1, FIG. 2, FIG. 3, FIG. 4, and FIG. 5. The operations from 602 to 612 may be implemented, for example, by the communication device 102 of FIG. 1 or the circuitry 202 of FIG. 2. The operations of the flowchart 600 may start at 602 and proceed to 604.

At 604, the first profile including the first set of features or settings of the communication device 102 may be received from the server 104, wherein the received first profile may be configured to control the communication device 102. In accordance with an embodiment, the circuitry 202 may be configured to receive, from the server 104, the first profile including the first set of features or settings of the communication device 102. The received first profile may be configured to control the communication device 102. As discussed, when a customer arrives to a shop or a showroom for the purchase of the communication device 102, a dealer or a seller may wish to demonstrate certain features or settings of the communication device 102 to persuade the customer to purchase the communication device 102. The first profile (such as, the first profile 402A) may include such features or settings. The circuitry 202 may automatically generate the first profile or receive the first profile from the server 104. Alternatively, dealer or seller may manually generate the first profile based on a manual selection of features and settings. In an embodiment, the first profile may be a default profile of the communication device 102. Details about the first profile generation are described, for example, in FIG. 4 (at 402).

At 606, the location of the communication device 102 may be tracked using the location sensor (such as, the location sensor 210 of FIG. 2). In accordance with an embodiment, the circuitry 202 may be configured to track, using the location sensor 210 associated with the communication device, the location of the communication device 102. The location of the communication device 102 may be tracked continuously, periodically, or when the communication device 102 moves from the predefined location (such as, the predefined location 112 of FIG. 1). The tracking of the location of the communication device 102 is described further, for example, in FIG. 4 (at 404).

At 608, it may be determined whether the communication device 102 is beyond the predefined distance (such as, the predefined distance 116) of the predefined location (such as, the predefined location 112A of FIG. 1), based on the tracked location of the communication device 102. In accordance with an embodiment, the circuitry 202 may be configured to determine whether the communication device 102 is beyond the predefined distance 116 of the predefined location 112A, based on the tracked location of the communication device 102. As discussed, the predefined location 112 may be the location of the dealer such as, the location of the shop, the showroom, and the like. The dealer or the seller may keep the unsold communication device 102 within the predefined distance 116. Before the communication device 102 is purchased by the customer, the customer may not move the communication device 102 beyond the predefined distance 116. Details about the comparison of the tracked location to the predefined distance are described, for example, in FIG. 4 (at 406).

At 610, the ownership update information (such as, the ownership update information 408A) indicative of the event of the ownership change associated with the communication device 102 may be received. In accordance with an embodiment, the circuitry 202 may be configured to receive ownership update information 408A indicative of the event of the ownership change associated with the communication device 102. As discussed, the ownership update information 408A may include information pertaining to the change of ownership of the communication device 102. Initially, the communication device 102 may be owned by the dealer or the seller. However, when the customer purchases the communication device 102, the ownership of the communication device 102 may be transferred from the dealer or the seller to the customer. Details about the reception of the ownership update information are described, for example, in FIG. 4 (at 408).

At 612, the first profile (such as, the first profile 402A) may be removed from the communication device 102, based on the determination that the tracked location is beyond the predefined distance 406A and the received ownership update information 408A. In accordance with an embodiment, the circuitry 202 may be configured to remove the first profile 402A from the communication device 102, based on the determination that the tracked location is beyond the predefined distance 406A and the received ownership update information 408A. As discussed, the first profile 402A may be used by the dealer or the seller of the communication device 102 to persuade the user 118 to purchase the communication device 102. After, the communication device 102 is purchased by the user 118, the first profile 402A may no longer be needed. Once the user 118 purchases the communication device 102 and moves the communication device 102 beyond the predefined distance 406A, the circuitry 202 may automatically remove the first profile 402A from the communication device 102. Details about the removal of the first profile are described, for example, in FIG. 4 (at 410). Further, the communication device 102 may receive a user input and generate a second profile based on the received user input. The reception of the user input and the generation of the second profile are described further, for example, in FIG. 4 (at 412 and 414).

Although the flowchart 600 is illustrated as discrete operations, such as 604, 606, 608, 610, and 612 the disclosure is not so limited. Accordingly, in certain embodiments, such discrete operations may be further divided into additional operations, combined into fewer operations, or eliminated, depending on the particular implementation without detracting from the essence of the disclosed embodiments.

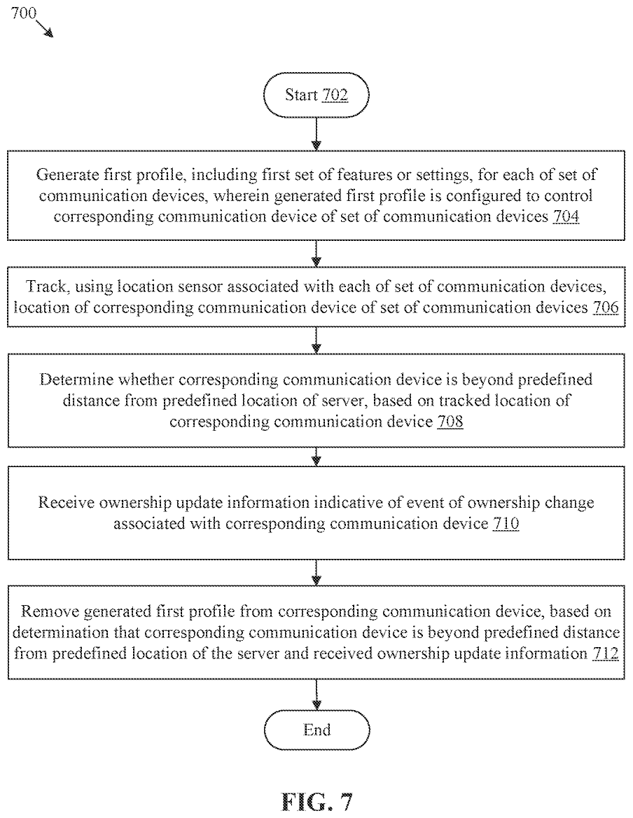

FIG. 7 illustrates a flowchart of an exemplary method for automatic profile configuration by a server based on location and ownership change of a communication device, in accordance with an embodiment of the disclosure. With reference to FIG. 7, there is shown a flowchart 700. The flowchart 700 is described in conjunction with elements from FIG. 1, FIG. 2, FIG. 3, FIG. 4, FIG. 5, and FIG. 6. The operations from 702 to 712 may be implemented, for example, by the server 104 of FIG. 1 or the circuitry 302 of FIG. 3. The operations of the flowchart 700 may start at 702 and proceed to 702.

At 704, the first profile, including the first set of features or settings, may be generated, for each of the set of communication devices 312, wherein the generated first profile may be configured to control the corresponding communication device of the set of communication devices. The circuitry 302 may be configured to generate the first profile (e.g., the first profile 502A), including the first set of features or settings, for each communication device (e.g., the first communication device 312A) of the set of communication devices 312. Alternatively, the circuitry 302 may retrieve the first profile from the database 106. The first profile may be configured to control the corresponding communication device of the set of communication devices 312. The generation of the first profile for each of the set of communication devices is described further, for example, in FIG. 5 (at 502).

At 706, the location of the corresponding communication device of the set of communication devices 312 may be tracked using the location sensor associated with each of the set of communication devices 312. In accordance with an embodiment, the circuitry 302 may track, using the location sensor (such as, the location sensor 210) associated with each communication device (e.g., the first communication device 312A) of the set of communication devices 312, the location of the corresponding communication device of the set of communication devices 312. The location may be tracked continuously, periodically, or when the corresponding communication device moves from the predefined location (such as, the predefined location 112A of FIG. 1). The tracking of the location of the corresponding communication device is described further, for example, in FIG. 5 (at 504).

At 708, it may be determined whether the corresponding communication device is beyond the predefined distance (such as, the predefined distance 506A) from the predefined location (such as, the predefined location 112A) of the server 104, based on the tracked location of the corresponding communication device. In accordance with an embodiment, the circuitry 302 may determine whether the corresponding communication device (e.g., the communication device 102) is beyond the predefined distance from the predefined location, based on the tracked location of the corresponding communication device. Details about the comparison of the tracked location are described, for example, in FIG. 5 (at 506).

At 710, ownership update information (such as, the ownership update information 508A) indicative of the event of the ownership change associated with the corresponding communication device may be received. In accordance with an embodiment, the circuitry 302 may receive the ownership update information 508A indicative of the event of the ownership change associated with the corresponding communication device (e.g., the first communication device 312A or the communication device 102). In an embodiment, the ownership update information may be received from a computing device or server associated with a back office of the dealer or the seller of the corresponding communication device (e.g., the first communication device 312A or the communication device 102). As discussed, the ownership update information 508A may contain information pertaining to the change of ownership of the corresponding communication device. Initially, the corresponding communication device may be owned by the dealer or seller. However, when the customer purchases the communication device, the ownership of the communication device may be transferred from the dealer or the seller to the customer. For example, once the customer purchases the communication device 102, a message may be transmitted to the computing device or the server of the back office (associated with the dealer or the seller). The message may indicate that the communication device 102 is sold. The message may also include identification and address details associated with the customer, payment details, sale transaction details, guarantee information, and other information. In an embodiment, the message may be transmitted by the communication device 102 or the server 104. The back office (or associated device/server) may verify the message and authorize an ownership update in a favor of the customer based on the verification of the message. Thereafter, the back office (or associated device/server) may transmit the ownership update information 408A to the communication device 102 to indicate of the event of the ownership change associated with the communication device 102. Details about the ownership update information are described, for example, in FIG. 5 (at 508).

At 712, the first profile (such as, the first profile 502A) may be removed from the corresponding communication device (e.g., the first communication device 312A), based on the determination that the corresponding communication device is beyond the predefined distance (such as, the predefined distance 506A) from the predefined location and the received ownership update information (such as, the received ownership update information 508A). In accordance with an embodiment, the circuitry 302 may remove the first profile 502A from the corresponding communication device, based on the determination that the corresponding communication device is beyond the predefined distance from the predefined location and the received ownership update information 508A. Details about the removal of the first profile are described, for example, in FIG. 5 (at 510). Further, the corresponding communication device may receive a user input and generate a second profile based on the received user input. The reception of the user input and the generation of the second profile are described further, for example, in FIG. 4 (at 412 and 414).

Although the flowchart 700 is illustrated as discrete operations, such as 704, 706, 708, 710, and 712 the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide non-transitory computer-readable medium having stored thereon. The computer-executable instructions may be executed by the communication device 102 may cause the communication device 102 to execute operations. The operations may include reception, from a server (e.g., the server 104), a first profile (such as, the first profile 402A) including a first set of features or settings of the communication device 102. Herein, the received first profile may be configured to control the communication device 102. The operations may further include tracking, using a location sensor (such as, the location sensor 210) associated with the communication device 102, the location of the communication device 102. The operations may further include a determination of whether the communication device 102 is beyond a predefined distance (such as, the predefined distance 406A) of a predefined location (such as, the predefined location 112A), based on the tracked location of the communication device 102. The operations may further include a reception of ownership update information (such as, the ownership update information 408A) indicative of the event of an ownership change associated with the communication device 102. The operations may further include a removal of the first profile 402A from the communication device 102, based on the determination that the tracked location (e.g., location 404A) is beyond the predefined distance 406A and the received ownership update information 408A.

Various embodiments of the disclosure may provide non-transitory computer-readable medium having stored thereon. The computer-executable instructions may be executed by the server 104 may cause the sever 104 to execute operations. The operations may include generation of a first profile (such as, the first profile 502A) including a first set of features or settings of each of a set of communication devices. Herein, the generated first profile may be configured to control the corresponding communication device. The operations may further include tracking, using a location sensor (such as, the location sensor 210) associated with the corresponding communication device, the location of the corresponding communication device. The operations may further include a determination of whether the corresponding communication device is beyond a predefined distance (such as, the predefined distance 506A) of a predefined location (such as, the predefined location 112A), based on the tracked location of the corresponding communication device. The operations may further include reception of ownership update information (such as, the ownership update information 508A) indicative of the event of an ownership change associated with the corresponding communication device. The operations may further include a removal of the first profile 502A from the corresponding communication device, based on the determination that the tracked location (e.g., location 504A) is beyond the predefined distance 506A and the received ownership update information 508A.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. A communication device, comprising:
circuitry configured to:
receive, from a server, a first profile including a first set of features or settings of the communication device, wherein the received first profile is configured to control the communication device;
track, using a location sensor associated with the communication device, a location of the communication device;
determine whether the communication device is beyond a predefined distance from a predefined location, based on the tracked location of the communication device;
receive, from the server, ownership update information indicative of an event of an ownership change associated with the communication device; and
remove the received first profile from the communication device, based on the determination that the communication device is beyond the predefined distance from the predefined location and the received ownership update information.

2. The communication device according to claim 1, wherein the received first profile includes information related to at least one of social applications, streaming services, Radio Detection and Ranging (RADAR) features, preloaded destinations, test drives, temperature settings, Heating Ventilation and Air-Conditioning (HVAC) settings, or tutorials associated with an infotainment system of the communication device.

3. The communication device according to claim 1, wherein the communication device is at least one of a vehicle, a mobility device, a mobile device, a consumer electronic device with the location sensor, or a computing device with the location sensor.

4. The communication device according to claim 1, wherein the ownership update information includes one or more of identification information of the communication device, a name of a user associated with the communication device, an address of the user, and payment details associated with the ownership update information of the communication device.

5. The communication device according to claim 1, wherein the circuitry is further configured to:
receive a user input including information indicative of a second set of features or settings of the communication device;
generate a second profile associated with a user of the communication device, based on the received user input; and
remove the received first profile from the communication device further based on the generated second profile associated with the user, wherein the generated second profile is configured to control the communication device based on the removal of the first profile from the communication device.

6. The communication device according to claim 5, wherein the user input is received based on the received ownership update information.

7. The communication device according to claim 1, wherein the circuitry is further configured to transmit a notification indicative of an instruction to return the communication device to the predefined location, based on the determination that the communication device is beyond the predefined distance from the predefined location.

8. The communication device according to claim 1, wherein the circuitry is further configured to:
start a timer on the communication device, based on a movement of the communication device from the predefined location;
compare a value of the started timer with a preset time duration;
determine whether the value of the started timer exceeds the preset time duration, based on the comparison; and
remove the received first profile from the communication device further based on the determination that the value of the started timer value exceeds the preset time duration.

9. The communication device according to claim 1, wherein the communication device corresponds to a vehicle, and the predefined distance from the predefined location corresponds to an area within which the vehicle is to be driven for a test drive.

10. The communication device according to claim 1, wherein the circuitry is further configured to remove the received first profile from the communication device based on at least one of a sign off from the received first profile, a disablement of the received first profile, or a reset of settings or features of the communication device to a pre-set state.

11. The communication device according to claim 1, wherein the server is associated with a first user, wherein the communication device is associated with a second user different from the first user.

12. A method, comprising:
in a communication device:
receiving, from a server, a first profile including a first set of features or settings of the communication device, wherein the received first profile is configured to control the communication device;
tracking, using a location sensor associated with the communication device, a location of the communication device;
determining whether the communication device is beyond a predefined distance from a predefined location, based on the tracked location of the communication device;
receiving, from the server, ownership update information indicative of an event of an ownership change associated with the communication device; and
removing the received first profile from the communication device, based on the determination that the communication device is beyond the predefined distance from the predefined location and the received ownership update information.

13. The method according to claim 12, wherein the received first profile includes information related to at least one of social applications, streaming services, Radio Detection and Ranging (RADAR) features, preloaded destinations, test drives, temperature settings, Heating Ventilation and Air-Conditioning (HVAC) settings, or tutorials associated with an infotainment system of the communication device.

14. The method according to claim 12, wherein the communication device is at least one of a vehicle, a mobility device, a mobile device, a consumer electronic device with the location sensor, or a computing device with the location sensor.

15. The method according to claim 12, wherein the ownership update information includes one or more of identification information of the communication device, a name of a user associated with the communication device, an address of the user, and payment details associated with the ownership update information of the communication device.

16. The method according to claim 12, further comprising:
receiving a user input including information indicative of a second set of features or settings of the communication device;
generating a second profile associated with a user of the communication device, based on the received user input; and
removing the received first profile from the communication device further based on the generated second profile associated with the user, wherein the generated second profile is configured to control the communication device based on the removal of the first profile from the communication device.

17. The method according to claim 16, wherein the user input is received based on the received ownership update information.

18. The method according to claim 12, further comprising transmitting a notification indicative of an instruction to return the communication device to the predefined location, based on the determination that the communication device is beyond the predefined distance from the predefined location.

19. A non-transitory computer-readable medium having stored thereon, computer-executable instructions that when executed by a processor, causes the processor to execute operations, the operations comprising:
generating a first profile, including a first set of features or settings, for each of a set of communication devices, wherein the generated first profile is configured to control a corresponding communication device of the set of communication devices;
tracking, using a location sensor associated with each of the set of communication devices, a location of the corresponding communication device of the set of communication devices;
determining whether the corresponding communication device is beyond a predefined distance from a predefined location, based on the tracked location of the corresponding communication device;
receiving ownership update information indicative of an event of an ownership change associated with the corresponding communication device; and
removing the generated first profile from the corresponding communication device, based on the determination that the corresponding communication device is beyond the predefined distance from the predefined location and the received ownership update information.

20. The non-transitory computer-readable medium according to claim 19, wherein the corresponding communication device is at least one of a vehicle, a mobility device, a mobile device, a consumer electronic device with the location sensor, or a computing device with the location sensor.
